(19) United States
(12) Patent Application Publication
(10) Pub. No.: US 2004/0064827 A1
(43) Pub. Date: Apr. 1, 2004

(54) Selection of a dispatch routine by a driver

(76) Inventor: David P. Cox, Santa Barbara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/260,386

(22) Filed: Oct. 1, 2002

(51) Int. Cl. G06F 3/00

(52) U.S. Cl. 719/321; 710/1

(57) ABSTRACT

A driver code arrangement, usable with a system having a bus that connects a host to a device, selects a dispatch routine to handle an input/output (IO) request packet (IRP) that is traversing a stack of device objects representing a portion of a communications path between the host and the device. Such a driver includes: a first code portion to receive the IRP; a second code portion to retrieve a set of data that identifies dispatch routines that are appropriate to the type of the device and/or the location within the stack associated with the code arrangement; a third code portion to extract, from the IRP, an indicator of the type of IO request which the IRP represents; and a fourth code portion to select a member from the set based upon the indicator which identifies a dispatch routine that is also appropriate to the type of request being made.

### BACKGROUND OF THE INVENTION

The WINDOWS driver model (WDM) is a driver technology developed by the MICROSOFT Corporation that supports drivers which are compatible for WINDOWS 98, 2000, ME AND XP. WDM allots some of the work of the device driver to portions of the code that are integrated into the operating system. These portions of code handle low-level buffer management, including direct memory access (DMA) and plug-n-play (PnP) device enumeration. WDM is a superset of the WINDOWS NT driver model (NTDM), to which it adds Plug & Play and power-management support.

In a layered software architecture such as WDM or NTDM, part of a communications path between a device/logical-unit (LUN) and an input/output (IO) initiator (e.g., an application on a host connected to the device/LUN via a bus) is a stack of device objects.

By convention, stacks are said to be built from the bottom up (with the device/LUN being below the bottom of the stack) and dismantled from the top down (with an IO initiator above the top of the stack). It is noted that describing a position in the stack as being relatively lower in the stack connotes being closer in terms of directness of communication to the device, while higher connotes being farther away. The bottom-most device object is created by the driver for the bus that provides access to the device and is called the physical device object (PDO). The bus driver provides raw communications capability to the device, but little in the way of higher-level device-specific functionality.

Generally there may be three types of device objects (DOs) in a stack: a physical DO (PDO); a function DO (FDO); and filter DOs (FiDOs). Typically a function device object (FDO) is created by a driver which provides access to device-specific and higher-level capabilities of the device. An FDO will be located higher in the device stack than a PDO. In addition to the PDO and FDO, there may optionally be one or more filter device objects (FiDOs). Such FiDOs may be located in the device stack between the PDO and FDO, or above the FDO.

One or more drivers in a stack might handle the IO request represented by an IRP. Dispatch routines within a driver actually do the handling (or dispatching) of the IRPs.

A DRIVER_OBJECT data structure, corresponding to a single loaded device driver according to WDM, contains a table of function pointers referred to as the dispatch table. The numerical values used to index into the table, namely to find specific functions, are called function codes and are given symbolic names that refer to a type of input/output (IO) such as READ and WRITE or refer to other requests such as CREATE, DEVICE_CONTROL and PnP.

The function located in the table at the corresponding index is expected to implement logic for carrying out such an IO request. The operating system delivers IO request packets (IRPs) to these functions. The operating system also, for each IRP, identifies the device for which the request is intended, in the form of a device object (DO) data structure. Such a DO was previously initialized by the driver and (as part of a stack including other DOs associated with other drivers) represents a single device handled (driven) by the driver. A driver defines its own dispatch functions and inserts them into the dispatch table in its DRIVER_OBJECT at the time the driver initializes itself.

FIG. 1 is a software block diagram that illustrates the layered relationships of objects according to the WDM architecture. Such a WDM architecture 100 includes a device 102 and a bus 104 to which the device 102 is physically connected. A host computing device 105 is also connected to the bus 104. The host 105 includes a variety of software such as an enumerator of bus devices (hereafter DO enumerator) 110, application 106, a input/output (IO) manager 108, a bus function driver 112, and a device function driver 116. It is noted that a device can also have one or more lower filter drivers and one or more upper filter drivers or none at all.

The operating system (OS) locates and loads into volatile memory the drivers for the bus 104 and the devices 102 connected to it. Once loaded, the drivers can create PDOs and/or create and attach corresponding FiDOs or FDOs to the stacks rooted in the PDOs, respectively.

A stack 134 for the bus 104 is depicted in FIG. 1. The stack 134 includes a PDO for the bus 130 (generated by the bus DO enumerator 110) and a bus FDO 132 (generated by the bus function driver 112). A stack 128 for the device 102 has also been created. The stack 128 includes a PDO 120 (generated by the bus function driver 112), and (possibly) a FiDO 122 (generated by the optional device lower filter driver 114, if present), an FDO (generated by the device function driver 116) and (possibly) a FiDO 126 (generated by the device upper filter driver 118, if present). In other words, if the device lower filter driver 114 and/or the device upper filter driver 118 are not present, then the FiDO 122 and/or the FiDO 126 will not be present, respectively.

FIG. 4 is a flow diagram that depicts in an abbreviated manner how dispatch routines for handling an IRP are selected by a driver according to the Background Art. The following is to be noted before discussing FIG. 4 in detail. An IRP includes a major function code that represents the type of IO request being made, e.g., read, write, create, close, etc. As mentioned above, an array of dispatch routines that handle an IRP is created when the corresponding driver is initialized. The array correlates addresses of appropriate dispatch routines with values that the major function code can take. In other words, the array is a request-specific array. Also, when a DO for a multifunction driver (as contrasted with a single function driver) (to be discussed below) is created, a field in its corresponding device extension is populated with an indication of the role (to be discussed further below) of the DO. The role represents two factors, namely the type of the device which the stack represents and the location within the stack of the DO.

At reference no. 400 the OS takes the major function code value from the IRP and (at 402) indexes it into the array of request-specific dispatch routines for the driver. At 404, the IO manager 108 calls the dispatch routine at the address determined by the index operation. At 406, the dispatch routine for a multifunction driver gets the role value stored in a field of the DO's extension. Using a branching logic code portion that operates on the role value, the dispatch routine determines which of a plurality of code portions (possibly subroutines) is appropriate for the role of the DO. At 410, the appropriate code portion is invoked.

The code portion chosen at 410 is role-specific and request-specific. This contrasts with the dispatch routine identified at 404, which is only request-specific. In effect, the dispatch routine determined at 404 is a set of IRP-handling code portions in view of its included branching logic that yields the code portion appropriate to the type of request.

FIG. 5 is a software block diagram of a layered architecture 500 according to the Background Art for the circumstance in which there is a multifunction driver. Such a driver is multifunctional in the sense that it can serve multiple types of devices and it can attach DOs at different locations in the different stacks representing the multiple devices.

For simplicity, in addition to the bus 502 and the host 503, the architecture 500 has been depicted as including only two devices, namely a disk device 504 and a tape device 506. Also depicted are a type of bus driver 508, a bus functional driver 510, the multifunction driver 512, a disk function driver 514 and a tape function driver 516. The stacks in FIG. 5 have already been completed. Similar to FIG. 1, a PDO 518 has been created by the bus driver 508 and forms the root of the bus stack; a disk PDO 524 and a tape PDO 526 have been created by the bus function driver 510 and form the roots of the disk and tape stacks, respectively; a bus FDO 522 has been attached to the bus stack by the bus function driver 510; an FDO 534 has been attached to the disk stack by the disk function driver 514; and a tape FDO 536 has been attached to the tape stack by the tape function driver 516.

The multifunction driver 512 has attached: an upper FiDO 528 to the bus stack; an upper FIDO 540 in the tape stack; a lower FIDO 532 in the disk stack; and an upper FiDO 538 in the disk stack. As such, the multifunction driver 512 has to accommodate four different roles in FIG. 5. This means that the branching logic in each of the driver's dispatch routines must be able to choose from four possible code portions if flow diagram of FIG. 4 were applied (in particular, flow 406).

FIGS. 7A and 7B are sequence diagrams for a system 700 according the Background Art. FIG. 7A depicts the initialization of a driver and one of its device objects, while FIG. 7B depicts the passing of an IRP to a driver, including the selection of an appropriate dispatch routine. The system 700 includes an IO initiator 702, kernel 704 (e.g., WINDOWS NT, WDM, etc.) and a multifunction driver 706. Already created in the initialization process is a driver object 708 that has a dispatch table 710. Also previously created is a stack (not depicted) for the device corresponding to the driver 706. That stack includes device object 712. Objects are passive, hence they are depicted in dashed lines, as contrasted with the solid bars depicting activations of the actors, e.g., multifunction driver 706.

As to FIG. 7A, the kernel 704 is caused to load the driver 706, create the driver object 708 and instruct the driver 706 to initialize at action 722. At legend 724, the driver 706 begins to initialize, which includes populating the dispatch table 710, e.g., setting the value of the Read dispatch routine address at action 726, setting the Write dispatch routine address at action 728, etc. Upon completion, the driver 706 sends a success response 730 to the kernel 704.

At action 732, the kernel 704 tells the driver 706 to create a device object (DO). At action 733, the driver 706 determines the DO's role. At legend 734, the driver 706 begins the process of creating a DO. At action 736, the driver 706 passes the information needed by the kernel 704 to create a DO. At action 738, the kernel 704 creates the DO 716 and the device extension 718. At action 740, the kernel 704 returns the new DO 716 to the driver 706. At legend 742, the driver 706 begins orchestrating the attachment of the DO 716 to the stack.

At action 744, the driver 706 passes the necessary information needed by the kernel 704 to attach the DO 716 to the stack. At action 746, the kernel 704 attaches the DO 716 to the lower DO 712 by putting a pointer to the DO 716 in the DO 712. At action 748, the kernel 704 returns a successful result to the driver 706. At action 750, the driver 706 stores a pointer to the lower DO 712 in the device extension 718 of the DO 716. At action 752, the kernel 752 stores the role of the DO 716 (again, indicative of device type and stack location) in the device extension 718 of the DO 716. At action 754, the driver 706 indicates to the kernel 704 that the DO 708 has been successfully attached to the stack.

As to FIG. 7B, the IO initiator 702 (e.g., a higher-level driver, or the kernel acting on behalf of an application loaded on the host; not shown) begins to formulate an IO request by calling kernel 704 to allocate an IRP at action 756. At action 758 the kernel creates an IRP 720, which it should be realized is an object, not an actor. It returns the IRP 720 to the IO intiator with response 759. At legend 760, the IO initiator begins to set fields in the IRP that describe the particular IO request. At action 762, the IO initiator 702 sets the major function code in the IRP 720. At legend 764, the IO initiator begins the process of sending the IRP 720 down the stack, which includes calling the driver 706 via first passing the DO 716 and the IRP 720 to the kernel 704, at action 766.

At action 768, the kernel 704 obtains the pointer to the driver 706 from the DO 716. At action 770, the kernel 704 gets the major function code from the IRP 720. At action 772, the kernel gets the address of the dispatch routine for the IRP 720 by using the major function code to index into the driver's table 710. In other words, the kernel 704 obtains the driver's dispatch routine that is specific to the type of IO request identified by the major function code.

At action 774, the kernel calls, passing the DO 716 and the IRP 720, the dispatch routine in the driver 706. At action 776, the driver 706 gets the address of the device extension 718. At action 778, the driver 706 uses that address to get the role value of the DO 716 from the device extension 718.

At legend 780, the driver 706 executes the branching logic of the dispatch routine to determine, based upon the role, which of the code portions is appropriate. Again, the dispatch routine actually provides a set of IRP handling code portions, each of which is appropriate to the type of the request. It is only by provision of the branching logic within the dispatch routine that a code portion specific to the role can be identified.

At legend 782, the driver 706 invokes the appropriate code portion. At action 784, this code portion handles the IRP 720. This can include passing the IRP 720 down to the next lowest driver if the driver 706 is not intended to solely handle the IRP 720. At action 786, the driver 706 returns the result of the IRP processing to the kernel 704. And at action 788, the kernel 704 returns the result to the IO initiator 702.

The kernel according to the Background Art selects an appropriate dispatch routine by first narrowing down from the set of all possible dispatch routines to a dispatch routine providing a set of request-type-specific code portions. Then in the dispatch routine the driver selects from the request-specific set to determine a code portion that is also role-specific.

### SUMMARY OF THE INVENTION

An embodiment of the invention provides a driver code arrangement, usable with a system having a device, which selects a dispatch routine to handle an input/output (IO) request packet (IRP) that is traversing a stack of device objects representing a portion of a communications path between the host and the device. Such a driver includes: a first code portion to receive the IRP; a second code portion to retrieve a set of data that identifies dispatch routines that are appropriate to the type of the device and/or the location within the stack associated with the code arrangement; a third code portion to extract, from the IRP, an indicator of the type of IO request which the IRP represents; and a fourth code portion to select a member from the set based upon the indicator which identifies a dispatch routine that is also appropriate to the type of request being made.

Additional features and advantages of the invention will be more fully apparent from the following detailed description of example embodiments, the appended claims and the accompanying drawings.

### BRIEF DESCRIPTION OF THE DRAWINGS

FIG. 1 is a software block diagram according to the Background Art.

FIG. 2 is a hardware block diagram according to the an embodiment of the invention.

FIG. 3 is a hardware block diagram according to an embodiment of the invention.

FIG. 4 is a flow diagram according to the Background Art.

FIG. 5 is a software block diagram according to the Background Art.

FIG. 6 is a flow diagram according to an embodiment of the invention.

FIGS. 7A and 7B are sequence diagrams according to the Background Art.

FIGS. 8A and 8B are sequence diagrams according to an embodiment of the invention.

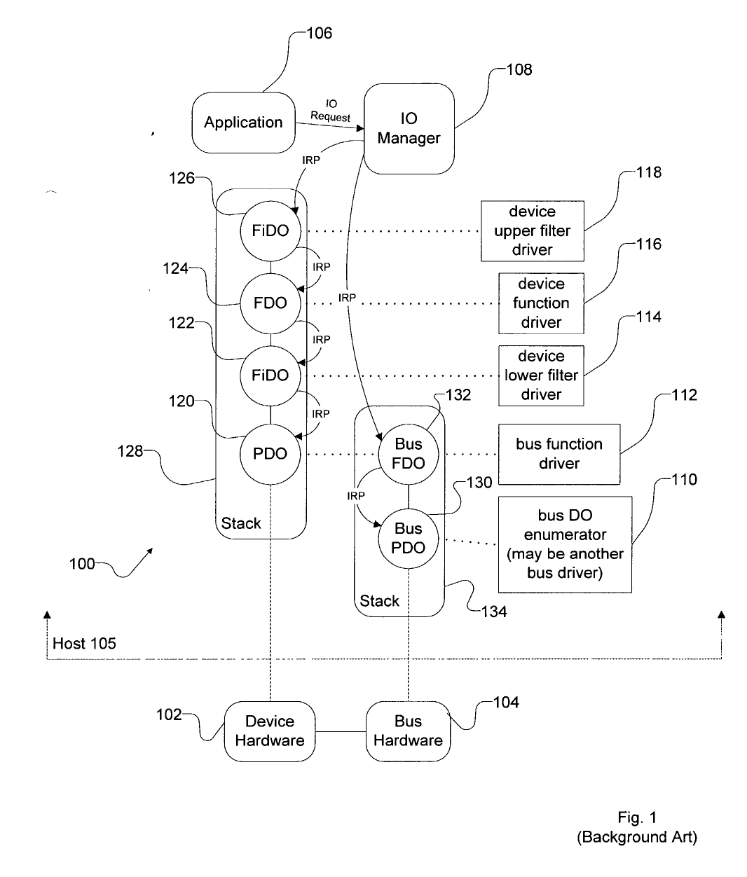

The accompanying drawings are: intended to depict example embodiments of the invention and should not be interpreted to limit the scope thereof; and not to be considered as drawn to scale unless explicitly noted.

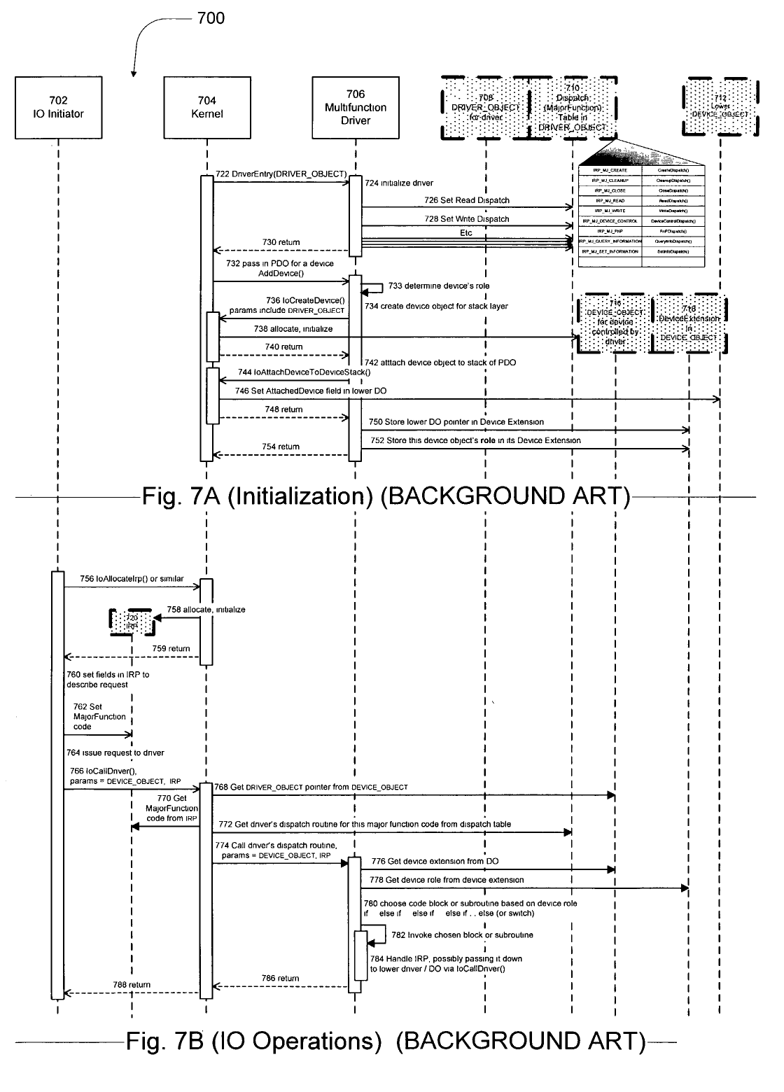

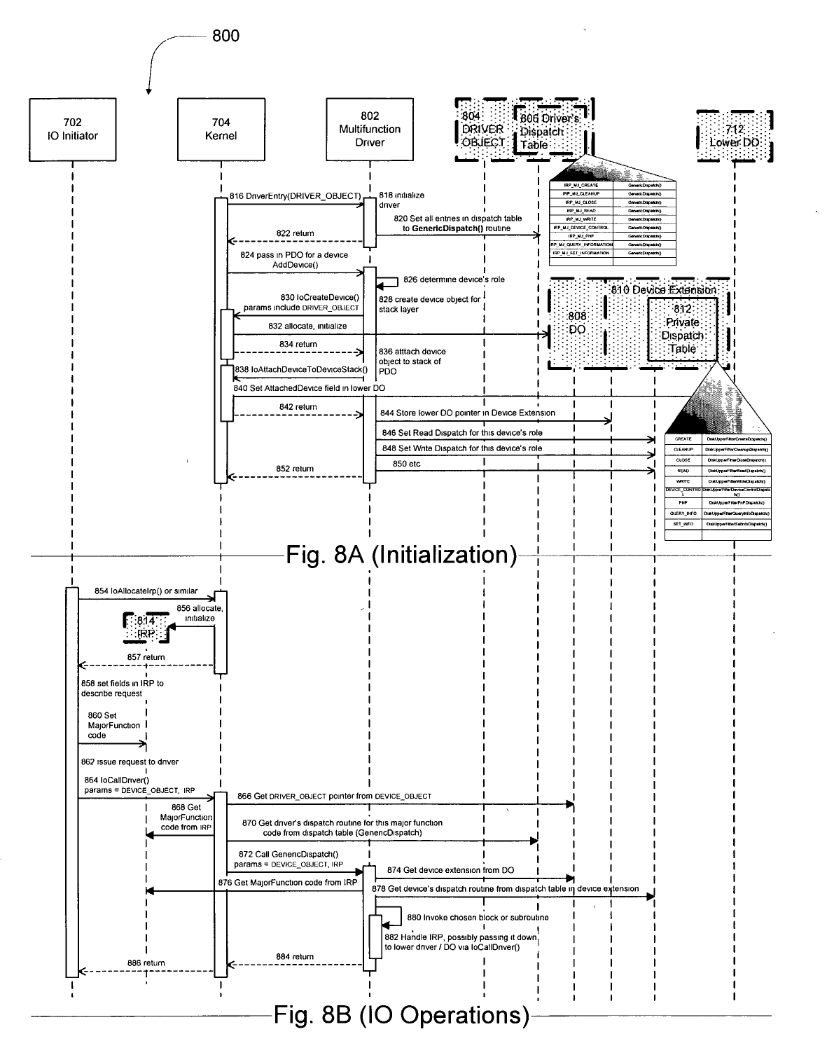

FIGS. 7A, 7B, 8A and 8B are UML sequence drawings. Actions are depicted with arrows of different styles. A [symbol] indicates an action that expects a response message. A [symbol] indicates a response message. [symbol] indicates an action for which the response is implied. And [symbol] indicates an action for which no response is expected.

### DETAILED DESCRIPTION OF THE PREFERRED EMBODIMENTS

Embodiments of the invention provide low level, (e.g., kernel-mode driver) software, e.g., a driver, that selects a dispatch routine to handle an input/output (IO) request packet (IRP) that is traversing a stack of device objects representing a portion of a communications path between the host of the driver and the device.

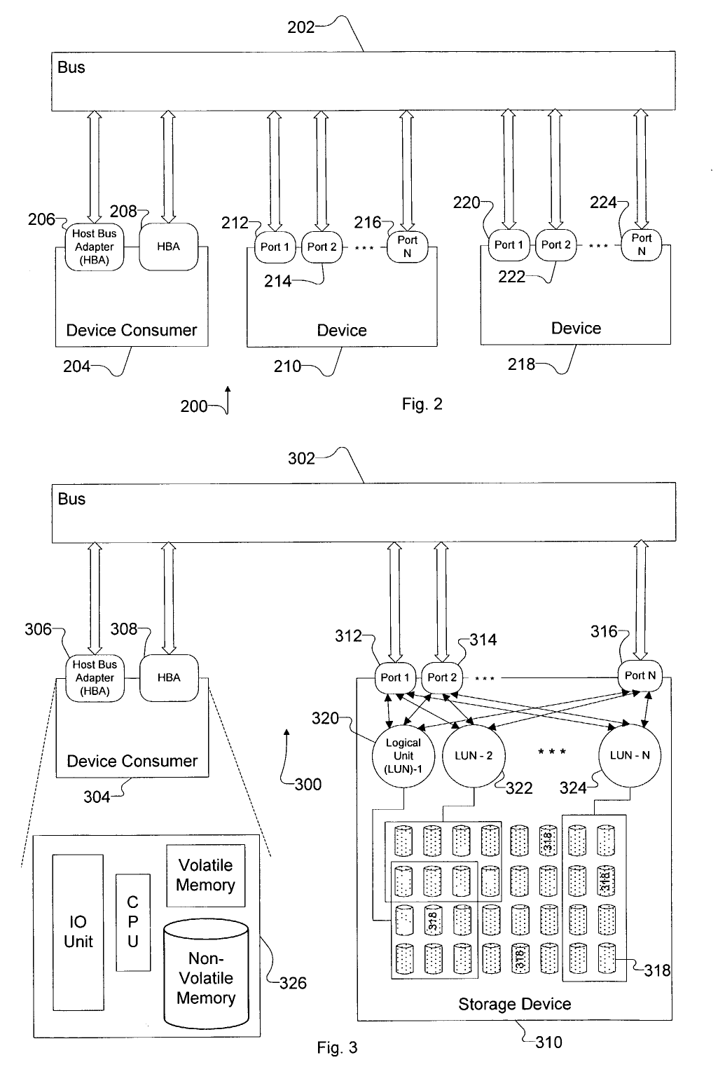

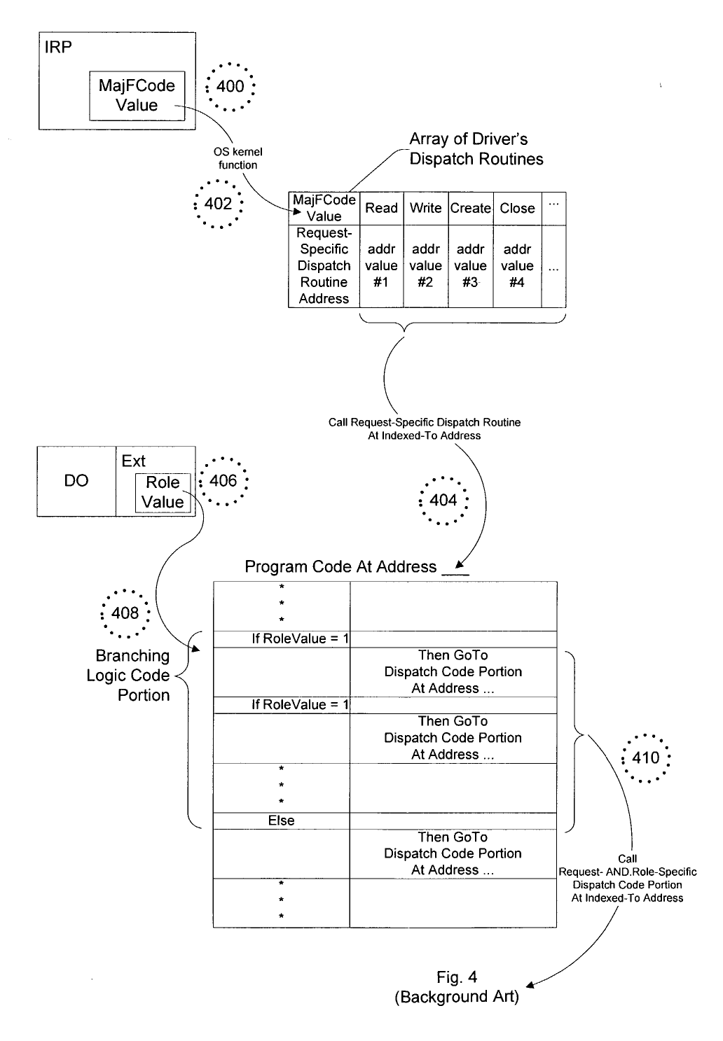

FIG. 2 depicts a hardware block diagram of a system 200 according to an embodiment of the invention that incorporates software according to an embodiment of the invention. The system 200 includes a bus (e.g., SCSI, Ethernet (iSCSI/IP/Gbit Ethernet), fibre channel, etc.) 202 to which is connected a consumer of device services (hereafter a device consumer) 204, a device 210 and a device 218.

FIG. 3 depicts a hardware block diagram corresponding to a particular type of system 200, namely a storage area system or storage area network (SAN) 300. The SAN 300 includes a bus 302, a device consumer 304 and a non-volatile storage device 310. The device consumer 304 can include HBAs 306 and 308. Fewer or greater numbers of HBAs 306/308 can be provided depending upon the circumstances of a situation.

The device consumer 304 can take the form of a computer 326 including at least a CPU, input device(s), output device(s) and memory. For example, the computer 326 has been depicted as including a CPU, an IO device, volatile memory such as RAM and nonvolatile memory such as ROM, flash memory, disc drives and/or tape drives.

The storage device 310 includes port 1 (312), port 2 (314), port N (316) and logical units (LUNs) 1, 2, . . . N. A LUN can represent a type of massive non-volatile storage, configuration functionality, monitoring functionality and/or mechanical functionality (such as tape changing), etc. Also included in the storage device 310 are non-volatile memories 318 such as disc drives, tape drives and/or flash memory. To remind the reader of the logical nature of a LUN, simplistic mapping between the LUNs 320, 322 and 324 and to physical memory devices 318 has been illustrated in FIG. 3.

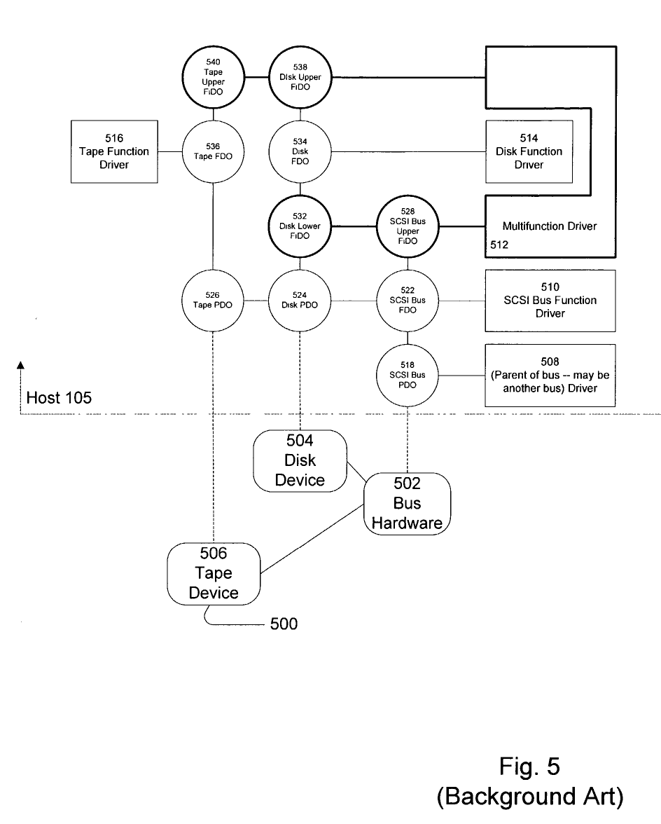

More generally, embodiments of the invention can apply to any system having a host and a device connected together by a bus. Examples of such systems are depicted in FIGS. 2 and 3, but also in Background Art FIG. 5.

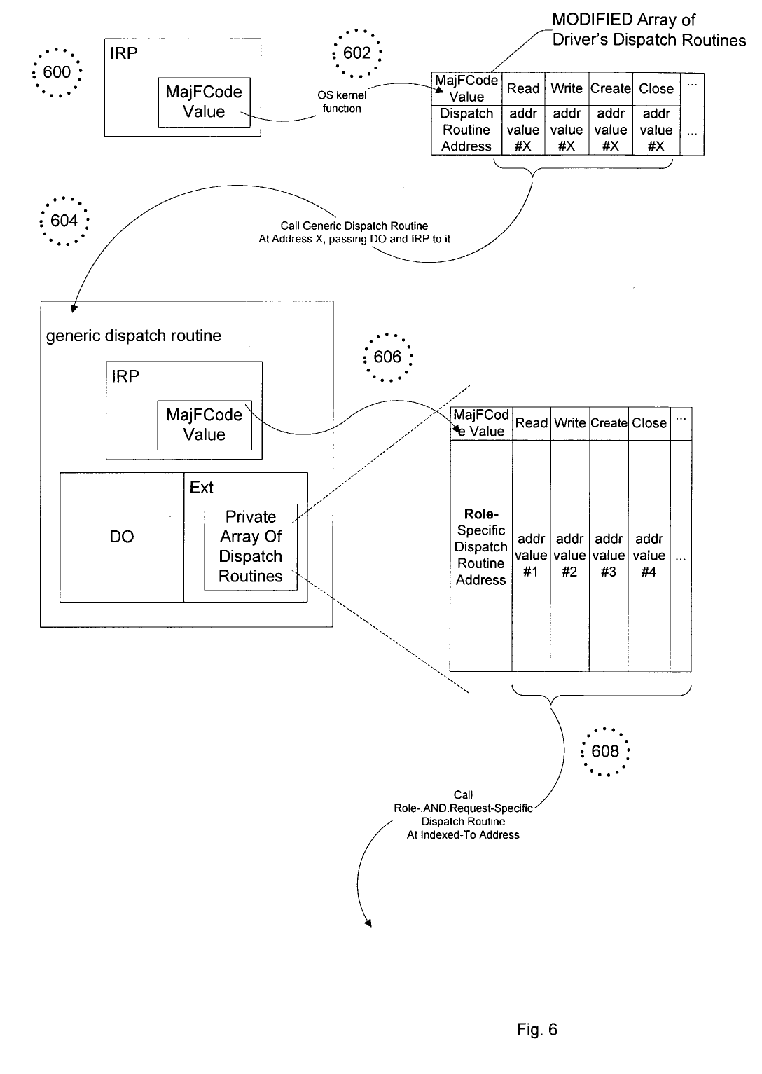

FIG. 6 is a flow diagram that depicts in an abbreviated manner how dispatch routines for handling an IRP are selected by a driver according to an embodiment of the invention. The following is to be noted before discussing FIG. 6 in detail. An array of dispatch routines that handle an IRP is created for a driver when the driver initializes, according to the NTDM OR VVDM, etc. The array is intended to correlate addresses of appropriate dispatch routines with values that the major function code can take. In other words, the array is a request-specific array. But according to an embodiment of the invention, the driver populates this array with a single address, namely that of a generic dispatch function (to be discussed below), rather than a plurality of addresses for request-specific dispatch routines as in the Background Art.

Also, a dispatch table (array) is stored in the device extensions corresponding to each DO created by the driver. This table, i.e., the DO's table, maps a set of role-appropriate dispatch routines to major function code values. Each of the routines is specific to the DO's role which, again, is a combination of the location of the DO in the stack and the type of the device that the stack (of which the DO is a part) represents.

At reference no. 600 of FIG. 6, the operating system (OS) takes the major function code value for the IRP and (at 602) uses it as an index into the driver's array of dispatch routine addresses, which has been populated to return the address of the generic dispatch routine irrespective of the value of the major function code.

At 604, the generic dispatch routine is called, with the DO and the IRP being passed to it. At 606, the private array of role-specific dispatch routines is retrieved from the DO's device extension and is indexed with the major function code obtained from the IRP. This obtains the address of a dispatch routine that is now request-specific as well as role-specific, which is called at 608.

The dispatch routine retrieved at 608 is request-specific and role-specific. This contrasts with the private array of dispatch routines retrieved at 606, which is role-specific but not request-specific.

FIGS. 8A and 8B are sequence diagrams for a system 800 according to an embodiment of the invention. FIG. 8A depicts the initialization of the driver and one of its device objects, while FIG. 8B depicts the selection of an appropriate dispatch routine when an IRP is passed to the driver. The system 800 includes an IO initiator 702 and a kernel 704 as in Background FIGS. 7A-7B. The system 800 also includes a multifunction driver 802. Already created in the initialization process is a driver object 804 that includes a dispatch table 806. Also previously created is a stack (not depicted) for the device corresponding to the driver 802. That stack includes device object 712, as in Background Art FIGS. 7A-7B. Objects are passive, hence they are depicted in dashed lines, as contrasted with the solid bars depicting activations of the actors, e.g., multifunction driver 802.

As to FIG. 8A, e.g., the kernel 704 is caused to load the driver 802, create the driver object 804 and instruct the driver 802 to initialize at action 816. At legend 818, the driver 802 begins to initialize, which includes populating the dispatch table (array) 806 at action 820.

In particular, the driver 802 does not populate the driver's dispatch table 806 as in the Background, i.e., with addresses of dispatch routines appropriate to the various IO requests that can be made (as represented by the MajFCode value). Instead, the driver 802 populates the array 806 with a single address, namely that of the generic dispatch function, rather than a plurality of addresses for request-specific dispatch routines as in the Background Art. Upon completion, the driver 806 sends a success response 822 to the kernel 704 (or a failure response if need be).

At action 824, the kernel 704 tells the driver 802 to create a device object (DO). At self action 826, the driver 802 determines role of the DO it is to create. At legend 828, the driver 802 begins creating the device object, which includes passing (at action 830) the information needed by the kernel 704 to create a DO for the driver 806. At action 832, the kernel 704 creates the DO 808 and the device extension 816 which, at the driver's direction, includes memory for the private dispatch table. At action 834, the kernel 704 indicates a result (successful or unsuccessful, here assumed for discussion purposes to be successful) to the driver 806. At legend 836, the driver 802 begins orchestrating the attachment of the DO 808 to the stack.

At action 838, the driver 802 passes the information needed by the kernel 704 to attach the DO 808 to the stack. At action 840, the kernel 704 attaches the DO 808 to the lower DO 712 by putting a pointer the DO 808 in the DO 712. At action 842, the kernel 704 returns a result (unsuccessful or—as assumed here—successful) to the driver 806.

At action 844, the driver 802 stores a pointer to the lower DO 712 in the device extension 810 of the DO 808. Then, the driver 802 begins to populate the DO's private dispatch table, including setting the address of a role-specific routine that is also appropriate to a READ request at action 846, setting the address of a role-specific routine that is also appropriate to a WRITE request at action 848, etc. (850). At action 852, the driver 806 indicates a result (unsuccessful or—as assumed here—successful) to the kernel 806 regarding attachment of the DO 808 to the stack.

A role value for a DO can be determined by querying and/or examining DOs below in the stack, drivers corresponding to the lower DOs, the devnode (in WDM) and/or the device, followed by providing the resulting information to a branching logic code portion. Such a branching logic code portion represents a predetermined heuristic which will vary depending upon the circumstances of the situations expected to be encountered.

As to FIG. 8B, the IO initiator 702 (e.g., a higher-level driver, or the kernel acting on behalf of an application loaded on the host; not shown) begins to formulate an IO request by calling the kernel 704 to allocate an IRP at action 854. At action 856 the kernel creates an IRP 814, which it should be realized is an object, not an actor. It returns the IRP 814 to the IO Initiator 702 with response 857. At legend 858, the IO initiator begins to set fields in the IRP 814 that describe the particular IO request. At action 860, the IO initiator 702 sets the major function code in the IRP 814. At legend 862, the IO initiator begins the process of sending the IRP 814 down the stack, which includes calling the driver 802 via first passing the DO 808 and the IRP 814 to the kernel 704, at action 864.

At action 866, the kernel 704 obtains the pointer to the driver object 804 from the DO 816. At action 868, the kernel 704 gets the major function code from the IRP 814. At action 870, the kernel gets the address of the dispatch routine for the IRP 814 by using the major function code to index into the driver's table 808. But unlike the Background Art, the driver's table 808 indexes all values of the major function code to the same address, namely that of the generic dispatch function.

At action 872, the kernel 704 calls the generic dispatch function in the driver, passing to it the DO 808 and the IRP 814 as parameters. At action 874, the driver 802 retrieves the address of the device extension 810. At action 876, the driver 802 retrieves the value of the major function code from the IRP 814. At action 878, the driver 802 uses the major function code value to index into the DO's dispatch table 812 (located in device extension 810) to retrieve a specific dispatch routine that is appropriate to the request represented by the IRP 814. At 880 the driver's generic dispatch routine calls the specific dispatch routine.

At action 882, the driver 802 handles the IRP by executing the specific dispatch routine. This can include passing the IRP 814 down to the next lowest driver if the driver 802 is not intended to solely handle the IRP 814. Then the driver 806 sends response 884 (unsuccessful or—as assumed here—successful) to the kernel 704. And at action 886, the kernel 704 passes the response (unsuccessful or—as assumed here—successful) to the IO initiator 702.

As an alternative, the DO's device extension can store a pointer to a table of dispatch routine addresses that is shared with other DOs in the same role, rather than storing an entire table of addresses in each device extension. This alternative uses less memory but is less flexible with respect to changing the DO behavior via changing its dispatch routines.

As another alternative, the technique according to embodiments of the invention of providing the DO with a private table of role-specific routines can be extended to route IRPs to routines based on IRP minor function codes as well as IRP major function codes. To do so, one defines yet another dispatch table (hereafter secondary dispatch table), also located in the DO's device extension; and an additional generic dispatch routine (hereafter secondary generic dispatch routine) for each major function code that a driver will handle this way. When initializing the device extension's table of major-function code routine pointers, the address of this major-code-specific generic function is placed in the table element for that major code. When the driver's primary generic dispatch routine receives an IRP with this major function code, it will call this secondary generic dispatch routine. The secondary generic routine looks at the IRP's minor function code, and uses it to index into the device extension's secondary dispatch table to locate a dispatch routine which is specific to the DOs role and the IRP's major and minor function codes. It then calls this routine, which handles the IRP. For example, this major/minor technique can be used to simplify handling of IRP_MJ_PNP requests because there are a large number of Plug and Play minor function codes (IRP_MN_*), and drivers that support Plug and Play are required to handle many of them.

The major/minor technique allows the developer to write dispatch functions that are each specific to a particular major and minor code combination. It is true that this can result in a large number of dispatch routines, but they are much simpler. Moreover, without these table-based routing approaches, there would be just as many subroutines or code portions for handling different major/minor combinations, but these would be in addition to the main dispatch routines responsible for identifying the code portion to invoke.

An advantage of embodiments according to the invention is that, when each device has its own private dispatch table 812, a developer can change the dispatch routine in effect for any major function code for that one device, as the driver runs, without impacting other devices. This allows the developer to change the behavior of the device, to reflect changes in the state of the device. If a device state is represented by the set of routine pointers in effect (i.e. present in the DO's private dispatch table(s)), then the routines themselves need less (or no) code for storing and checking state data fields in order to branch to different logic supporting different behaviors based on the current state. This is a reason why it might not be desirable for all device extensions of the same role to have pointers to a shared dispatch table, but rather would be desirable for each to have its own private table. If the device extensions shared a table, it could not be used to indicate the state of any particular device.

Another advantage of embodiments according to the invention is that the DO device extension can be a true object with true methods (whereas DOs are merely struct instances without methods). If the device extension is an object, and the array holds pointers to methods rather than pointers to functions, then the generic dispatch routine can call methods on the objects, rather than passing structs to functions. The distinction is that methods have the object as an implicit parameter, whereas functions are not object-oriented, so all structs must be passed as parameters. The device extension methods can access the device extension fields without it having been passed explicitly as a parameter. The benefit is largely about how a developer thinks about problems and their solutions, but it can also make code more brief so that the same results can be accomplished with less source code.

An embodiment of the invention is the recognition that with the approach to dispatch routine selection according to the Background Art for use with WINDOWS NT driver model (NTDM) and the newer WINDOWS Driver Model (WDM), the result is a small-to-moderate number of dispatch routines. In each of these routines, a developer must replicate the code, with minor variations, that identifies the DO role and branches to role-specific code portions. If a developer then writes another driver to solve a different problem, then the developer must write a new set of dispatch routines, but these must have similarly replicated role-identification branching code as well.

Accordingly, an embodiment of the invention can avoid having to write role identification or role-based branching code, and minor function code-based branching code in the dispatch routines. Instead, when the device object is created and initialized, its role can be determined, and the dispatch table(s) in its device extension can be initialized accordingly. This can represent significantly less code, e.g., as little as one function [such as AddDevice( ), by which the PnP Manager passes PDOs for a driver to attach their own DOs]. A generic dispatch routine (to be discussed below) takes care of the rest. This generic dispatch routine can be quite brief, and once written, can be reused in any number of drivers.

Accordingly, an embodiment of the invention consolidates code that would be scattered about the driver's dispatch routines to one place. Such an embodiment can do so because it narrows the universe of all possible dispatch routines (first) down to a set that is specific to the role of the device object (DO), and (second) selects from that set to obtain a dispatch routine that is also specific to the type of request (indicated by the major function code in the IRP).

An advantage to such embodiments of the invention is that the generic dispatch routine serves as a convenient place to put code that should be executed for every IRP because all IRPs will pass through the generic dispatch routine. This again saves the developer from replicating that code in every dispatch routine. For example, consider a debug-tracing function that can be located in the generic dispatch routine. When enabled, the debug-tracing function can write tracing information to its output every time it is called, saving information about the request (IRP) and device object (DO), which can help the developer understand the order in which different IRPs are delivered to the driver, and how that order is affected by a driver's responses to previous individual IRPs.

The invention may be embodied in other forms without departing from its spirit and essential characteristics. The described embodiments are to be considered only non-limiting examples of the invention. The scope of the invention is to be measured by the appended claims. All changes which come within the meaning and equivalency of the claims are to be embraced within their scope.

What is claimed is:

1. A driver code arrangement on a computer-readable medium,
for use in a system having a bus that connects a host to a device,
execution of said code arrangement by one or more processors selecting a dispatch routine to handle an input/output (IO) request packet (IRP) that is traversing a stack of device objects representing a portion of a communications path between said host and said device,
the computer-readable code arrangement comprising:
a first code portion to receive said IRP;
a second code portion to retrieve a set of data that identifies dispatch routines that are appropriate to at least one of the type of said device and said location within said stack associated with said code arrangement;
a third code portion to extract, from said IRP, an indicator of the type of IO request which said IRP represents; and
a fourth code portion to select a member from said set based upon said indicator, said member identifying a dispatch routine that is also appropriate to said type of request being made.

2. The computer-readable code arrangement of claim 1, wherein said set of data identifies dispatch routines that are appropriate both to the type of said device and to said location within said stack associated with said code arrangement.

3. The computer-readable code arrangement of claim 1, wherein said set of data is stored in an extension to a device object corresponding to said code arrangement.

4. The computer-readable code arrangement of claim 1, wherein said set of data is an array of pointers to the appropriate dispatch routines.

5. The computer-readable code arrangement of claim 1, wherein
said set is a first set;
said code arrangement has associated therewith a second set of data intended to identify dispatch routines that are appropriate to said type of request being made; and
said code arrangement further comprises:
a fifth code arrangement to populate said second set with data identifying the same routine irrespective of said type of request being made.

6. The computer-readable code arrangement of claim 5, wherein the routine identified by said second set corresponds to said first through fourth code portions.

7. The computer-readable code arrangement of claim 5, wherein said second set of data is a set of pointers.

8. The computer-readable code arrangement of claim 1, wherein said code arrangement conforms to the WINDOWS Driver Model (WDM) architecture or the WINDOWS NT driver model.

9. The computer-readable code arrangement of claim 1, wherein said system is a storage area network

10. A method, usable in a system having a bus that connects a host to a device, for selecting a dispatch routine to handle an input/output (IO) request packet (IRP) that is traversing a stack of device objects representing a portion of a communications path between said host and said device, the method comprising:
receiving said IRP;
retrieving a set of data that identifies dispatch routines that are appropriate to at least one of the type of said device and said location within said stack associated with said code arrangement;
extracting, from said IRP, an indicator of the type of IO request which said IRP represents; and
selecting a member from said set based upon said indicator, said member identifying a dispatch routine that is also appropriate to said type of request being made.

11. The method of claim 10, wherein said set of data identifies dispatch routines that are appropriate both to the type of said device and to said location within said stack associated with said code arrangement.

12. The method of claim 10, wherein said set of data is stored in an extension to a device object corresponding to said code arrangement.

13. The method of claim 10, wherein said set of data is an array of pointers to the appropriate dispatch routines.

14. The method of claim 10, wherein
said set is a first set;
there is a second set of data intended to identify dispatch routines that are appropriate to said type of request being made; and
said method further comprises:
populating said second set with data identifying the same routine irrespective of said type of request being made.

15. The method of claim 14, wherein the routine identified by said second set performs said receiving, said retrieving, said extracting and said selecting.

16. The method of claim 14, wherein said second set of data is a set of pointers.

17. The method of claim 10, wherein said stack and said IRP conform to the WINDOWS Driver Model (WDM) or the WINDOWS NT architectures.

18. The method of claim 10, wherein said system is a storage area network.

19. A driver usable with a host device in a system having a bus that connects a host to a device,
the host being operable to select a dispatch routine, to handle an input/output (IO) request packet (IRP) that is traversing a stack of device objects representing a portion of a communications path between said host and said device, by loading and executing a code arrangement according to claim 1.

20. A driver, usable in a system having a bus that connects a host to a device, for selecting a dispatch routine to handle an input/output (IO) request packet (IRP) that is traversing a stack of device objects representing a portion of a communications path between said host and said device, the driver comprising:
means for receiving said IRP;
means for retrieving a set of data that identifies dispatch routines that are appropriate to at least one of the type of said device and said location within said stack associated with said code arrangement;
means for extracting, from said IRP, an indicator of the type of IO request which said IRP represents; and
means for selecting a member from said set based on said indicator, said member identifying a dispatch routine that is also appropriate to said type of request being made.
